(19) United States
(12) Patent Application Publication
(10) Pub. No.: US 2016/0371400 A1
(43) Pub. Date: Dec. 22, 2016

(54) Installation System and Method for Mapping Components of a Structure

(71) Applicant: OMG, Inc., Agawam, MA (US)

(72) Inventors: Antonios Challita, Bellbrook, OH (US); Joshua S. Kelly, Longmeadow, MA (US); Tamilselvan Samiappan, Simsbury, CT (US); Tad A. Weiss, Westhampton, MA (US); Robert C. Cravens, II, Beavercreek, OH (US)

(21) Appl. No.: 15/185,126

(22) Filed: Jun. 17, 2016

Related U.S. Application Data
(60) Provisional application No. 62/182,205, filed on Jun. 19, 2015.

(51) Int. Cl. G06F 17/50; G01S 19/13; E04H 9/14; E04B 1/41; E04D 5/14; E04H 9/02

(52) U.S. Cl. CPC G06F 17/5004; E04D 5/149; E04H 9/021; E04H 9/14; E04B 1/40; G01S 19/13

(57) ABSTRACT

A position sensing construction system according to aspects of the disclosure may include a GPS system arranged to cover a jobsite, a local position sensing system in combination with the GPS system, tools equipped with position/movement sensors and communication capability, and software to record positions of installed building components. Local position sensing systems may utilize one or more known fixed points, the position of which is established by GPS or other techniques, and report the position of building components relative to the fixed positions. Installation tools are configured to deliver a position signal corresponding to the position of a building component after installation is completed. Software facilitates communication between system components, records position and other information from tools and generates maps of tagged locations that can be used during construction and later for repair and maintenance of the completed project. The positions and maps may be in three dimensions.

### BACKGROUND

The disclosure relates to the construction industry generally, and more specifically to systems and methods permitting users to identify, map, and record the position of building components as the components are installed.

Residential and commercial structures of all kinds include components and systems that are hidden from view, but the location of which may be critical to completion, inspection, and maintenance of the project. Various stages of inspection can only be conducted during periods when the relevant system or components to be inspected have not yet been buried or covered. However, some building components or systems are difficult to access even before they are buried or covered, complicating inspection. One common approach is to use architectural drawings and site plans to identify the location of hidden or buried components as necessary over the life of the project. However, actual construction can vary significantly from the plan, resulting in difficulty establishing the precise location of hidden or buried systems or components. Finding such systems or components may require expensive and disruptive demolition and/or excavation.

Modern building codes require structural reinforcements at various points to resist forces generated by tornadoes, hurricanes, earthquakes and other forces of nature. To comply with relevant building codes, structures must be inspected at pre-determined stages of construction when the relevant reinforcements can be verified. Missing or improperly installed reinforcements may lead to inspection failures, re-work and construction delays.

There is a need for systems that will ensure all code required reinforcements are installed and to assist contractors in identifying missing reinforcements prior to inspections.

There is an opportunity to apply a combination of technologies to identify, map and record the position of building systems and components during construction to produce a precise and accurate map for use during construction inspection and maintenance over the life of the structure.

### SUMMARY

Global Positioning Systems (GPS) are widely used to track movement and position of vehicles, people and objects around the world. Current GPS can be used to establish position to within 1 inch or about 20 mm. Other position and movement sensing technologies can be used to complement GPS capabilities in terms of accuracy in two dimensions and provide three dimensional positioning capabilities. Examples of movement sensing technologies that can be used in combination with GPS are real-time kinetic (RTK) and laser based systems. Local position measurement (LPM) using radio frequency (RF) transponders communicating with multiple base stations may also be employed.

A position sensing enabled construction system according to aspects of the disclosure may include a GPS system arranged to cover a jobsite, a local position sensing system in combination with the GPS system, tools equipped with position/movement sensors and communication capability, and software to record positions of installed building components. Local position sensing systems may utilize one or more known fixed positions, the position of which is established by GPS or other techniques, and report the position of building components relative to the fixed positions. Many GPS systems require that system components have a clear view of the sky, which may not be practical for some construction situations, such as work on lower floors of a multistory project. Local position reporting systems incorporating known position fixed points may remove the “open sky” requirement.

One or more tools are configured to deliver a position signal corresponding to the position of a building component after installation is completed. Software facilitates communication between system components, records position and other information from tools and generates maps of tagged locations that can be used during construction and later for repair and maintenance of the completed project. The positions and maps may be in three dimensions.

### BRIEF DESCRIPTION OF THE DRAWINGS

FIG. 1 illustrates a fixed position GPS repeater and position reporting fastener installation tool on a roof according to aspects of the disclosure;

FIG. 2 is an enlarged perspective view of the position reporting fastener installation tool of FIG. 1;

FIG. 3 is an enlarged partial rear perspective view of the lower portion of the position reporting fastener installation tool of FIG. 1;

FIG. 4 is an enlarged partial rear perspective view of the upper portion of the position reporting fastener installation tool of FIG. 1;

FIGS. 5-8 illustrate a robotic cart configured to carry a position reporting system according to aspects of the disclosure;

FIG. 9 is a graphical presentation of positions determined by a representative position sensing system;

FIG. 10 illustrates a representative tool installing a fastener to connect a wall top plate to a roof truss;

FIG. 11 illustrates a typical building structure and the connections necessary to provide a continuous load path from the roof to foundation;

FIG. 12 illustrates a flat roof showing a pattern of anchor plates used to secure a flat membrane to the underlying roof structure;

FIG. 13 is a representative three dimensional image of a structure showing the position of various components according to information from the disclosed systems and methods;

FIG. 14 is a schematic representation of a computer configured to host the disclosed systems;

FIG. 15 is a schematic representation of a tool compatible with the disclosed systems and methods; and

FIG. 16 is a schematic representation of an installation system according to aspects of the disclosure.

### DETAILED DESCRIPTION OF THE DISCLOSED EMBODIMENTS

Apparatus and methods for mapping the components and systems of a construction project will be discussed in the context of construction and completion of a building, but should be understood as broadly applicable to any component, system, or subsystem of a construction project whether inside the structure, mounted to the structure, or buried on the site.

Roof structures for residential and commercial construction are subject to numerous building code and safety requirements. The roof support structure must be sufficiently robust to support any systems mounted to the roof as well as any predicted snow or other load, with a safety factor built in. Further, modern building codes require roof structures to be constructed to withstand high wind lift forces from hurricanes and/or tornadoes. Relevant building codes reference various design specifications and/or standards, which may specify the number and location of roofing trusses and fastening components to ensure the roof structure will meet all relevant load and wind resistance requirements. Construction supervisors and architects need to verify that construction plans are being followed accurately. Building inspectors are tasked with entering the structure at various stages of construction to verify the presence and proper installation of the structural and fastening components of the roof system.

The disclosed systems and methods employ position reporting tools to mark the installed position of fasteners and other components of the structure. The positions of various components are recorded and can be used to generate three-dimensional maps of the building and its systems, precisely identifying the location of the marked components. The resulting map can be used to enhance construction supervision, inspection, and maintenance over the life of the structure. Three-dimensional digital maps of building components can be generated to show one or more sets of installed building components.

A first disclosed embodiment will be discussed in the context of a roofing membrane system applied to a flat roof. Roofing membranes are typically the final step in completing and weather proofing the roof of a commercial building. The membrane is typically applied over insulation which is supported by corrugated sheet metal panels (roof deck) attached to roof trusses and steel joists. Each layer of the roof system covers and obscures the structures beneath it. Anchor plates carrying heat-activated adhesive are secured to the roof structure by fasteners passing through the insulation. The roofing membrane is rolled out over the plates. Bonding tools placed on top of the roof membrane heat the adhesive, forming a secure bond between the membrane and the plates, as is known in the art. Finding the exact location of the plates under the membrane can be difficult, complicating the bonding and subsequent inspection of the roof.

Alternative uses for the disclosed installation and mapping systems include, but are not limited to, rebar (in concrete structures), roofing insulation plates, decking fasteners, joist hangers, metal roofing fasteners, tile roofing systems, exterior insulation and finish systems (EIFS), siding fasteners, framing and stud fasteners. Screw guns, pneumatic nailers and other fastener installation tools may be incorporated into the disclosed installation and mapping systems and methods.

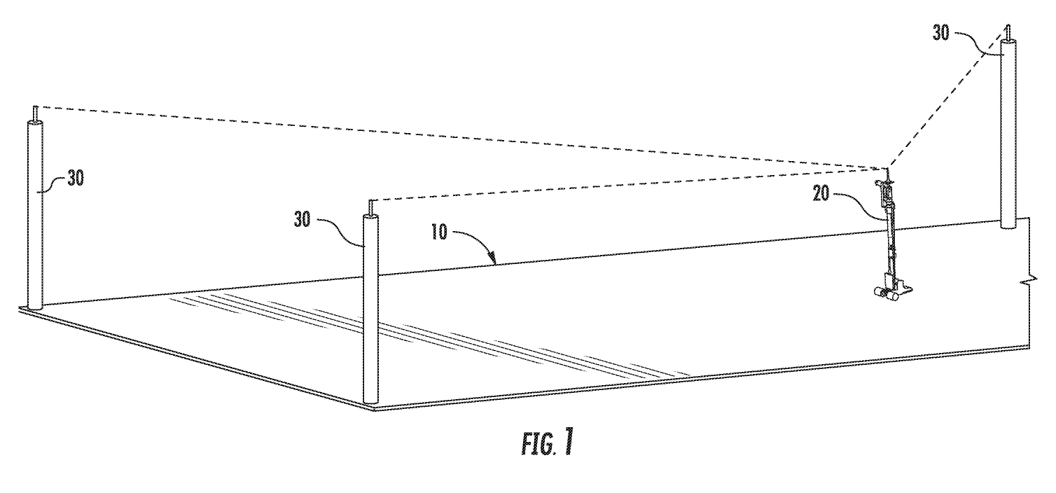

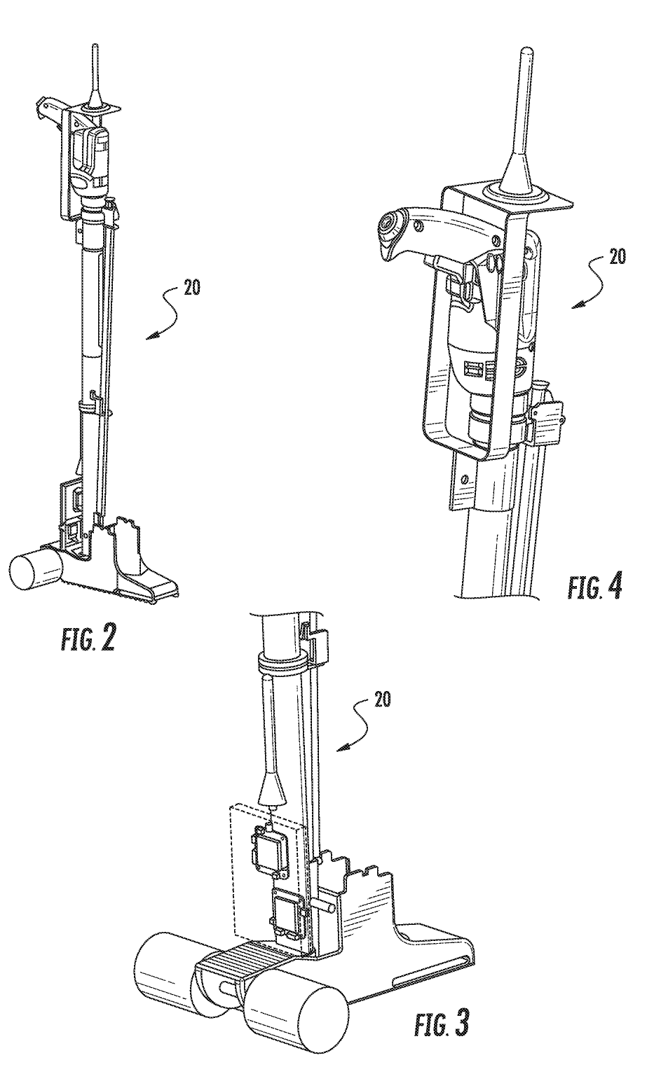

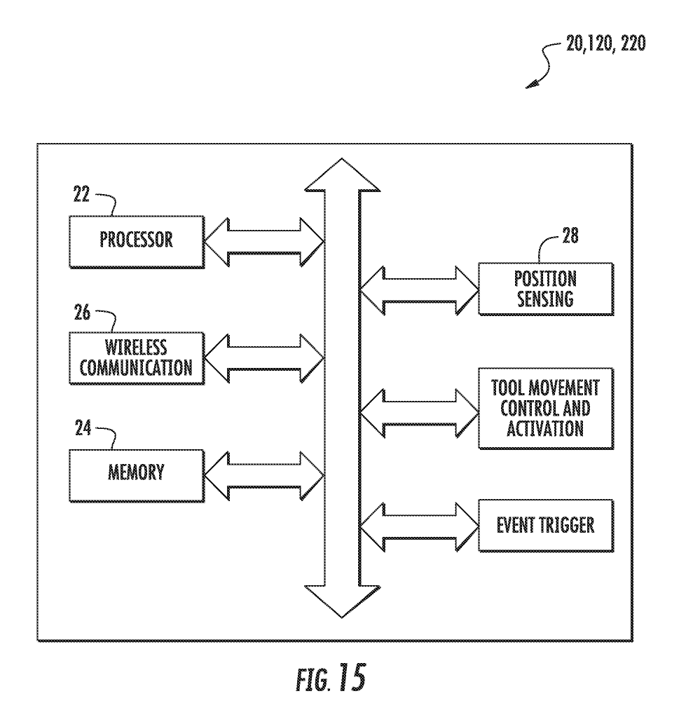

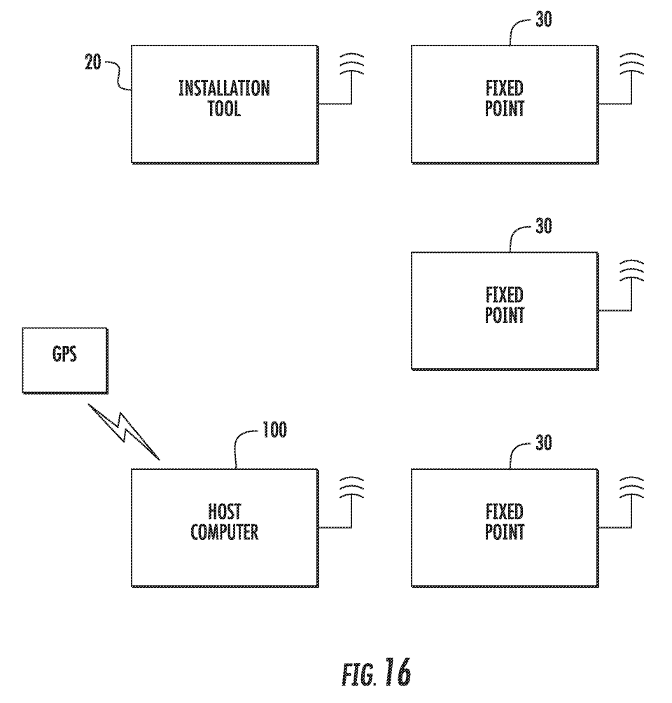

Part of the proposed system is to establish an enhanced position sensing system covering all or part of the construction site. FIG. 1 illustrates a flat roof 10, a plate installation tool 20 and several fixed points 30, each having a known position. The tool 20 and fixed points 30 are equipped to communicate wirelessly with each other and a host computer 100 such as illustrated in FIG. 14 to form a system as shown in FIG. 16. Wireless communication enables the tools 20 to report position information to the system upon occurrence of a pre-determined event, such as the completed installation of a building component. The installation tool 20 illustrated in FIGS. 1-4 is configured to drive a fastener such as a screw through an opening in the center of a bonding plate 50. The fastener passes through insulation beneath the plate 50 to engage an underlying roof structure, as is known in the art. The installation tool 20 may be equipped with switches or other signal generating components that are triggered by a completed fastener driving cycle. The signal corresponding to a completed fastener installation initiates a communication between the tool 20 and the host computer 100, where the tool 20 reports a completed fastener installation and the position of the installed fastener. The host computer 100 may utilize additional position information from fixed points 30 to refine the position of the installed fastener. The system records the fastener installation, time, date, and position for later use.

Signals from the tool 20 are received by one or more fixed points such as fixed point 30 and also the host computer 100, which is also equipped for wireless communication. Wireless communication among system components may also be employed to update or reconfigure software in the fixed points 30 and/or installation tool 20 or other programmable system assemblies. Bluetooth is one wireless communication protocol that may be compatible with the disclosed tools, systems and methods, but other methods of wireless communication will occur to those skilled in the art. Communication may be through wires (not shown) or by means other than traditional RF wireless protocols.

FIG. 14 schematically illustrates a representative host computer 100, which may be part of an installation and mapping system according to aspects of the disclosure. The host computer 100 includes memory, at least one processor, a display and user interface, as well as wireless communication capability. The host computer 100 may be located at the job site, or may be located off site, with communications accomplished via the internet using “cloud” computing strategies. The host computer 100 may be a traditional digital stand-alone computer, which may be hardened for use on a job site. Alternatively, the functions of the host computer 100 may be carried out by a smart phone, tablet or other computing device. The functions of the host computer 100 may be shared between one or more local devices, such as smart phones or tablet computers and one or more computers remote from the job site. Cloud computing strategies may be employed to enhance the computing power, memory or other aspects of the host computer.

Some GPS systems require a clear line of sight to the relevant GPS satellites, e.g., a vantage point open to the sky. However, localized position sensing networks can be established that reference fixed positions determined using GPS or other position determination methods, such as surveying. Several fixed points of known position arranged near a work site can be used to triangulate the position of a tool 20 being used on the work site such as a flat roof 10 to a high degree of accuracy. Local position sensing systems may employ kinetic (movement) information from the tool, laser position detection or other methods to determine the position of an installation tool 20 and associated building component. A representative installation tool 20 is schematically illustrated in FIG. 15. Laser position detection can be used to calibrate the system or to improve accuracy of position determination. It is important to note that the relevant position detection system must be capable of determining position in three dimensions, latitude, longitude and elevation.

As illustrated in FIG. 15, the installation tools 20, 120, 220 include digital components resembling a basic computer, including a processor 22, memory 24 and wireless communication 26. Firmware/software is stored in memory 24 and its steps are executed by the processor 22. A tool 20 according to the disclosure also includes components necessary to communicate the tool position (or component position, derived from the position of the tool) to the host computer 100. Communication between the host computer 100 and other system units such as the installation tool 20 and fixed points 30 can be employed to install, update or re-configure the firmware/software in the units. The position reporting components 28 of the tool will vary depending upon the position sensing system deployed on the work site. Position reporting components 28 may include GPS enabled components, RF transmitters, components capable of detecting kinetic movement of the tool or other components compatible with the selected position sensing system. The position reporting components 28 are constructed and arranged to provide an accurate report of the position of a building component (such as a roofing anchor plate) installed by the tool 20, and not the position of the tool itself. In this instance, the precise location of each fastener allows the system to generate a map showing the location of each anchor plate 50. The resulting map of anchor plates 50 is recorded by the host computer 100 and can be used to guide personnel tasked with heating each plate to bond the membrane to the roof.

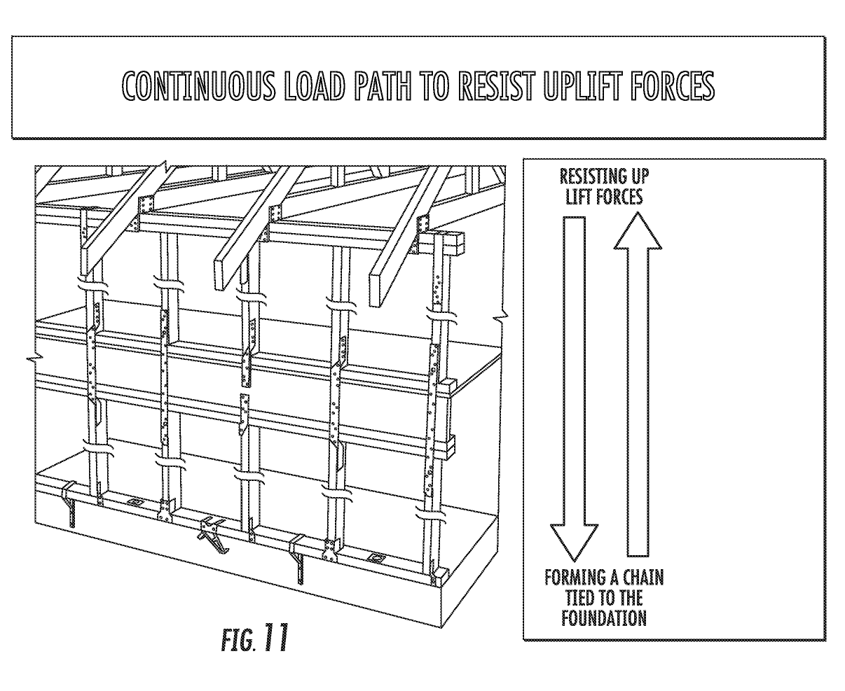

FIG. 9 is a graphical representation of positions determined by a representative differential GPS system. The positions reflect accuracy generally acceptable for the disclosed systems and methods. All the points fell within a 20 mm circle, with about ⅔ of the points falling within a 10 mm circle. This degree of positional accuracy is sufficient for most purposes contemplated for the disclosed installation tools, systems and methods, but accuracy can be enhanced by triangulation between fixed points of known location or other methods known in the art.

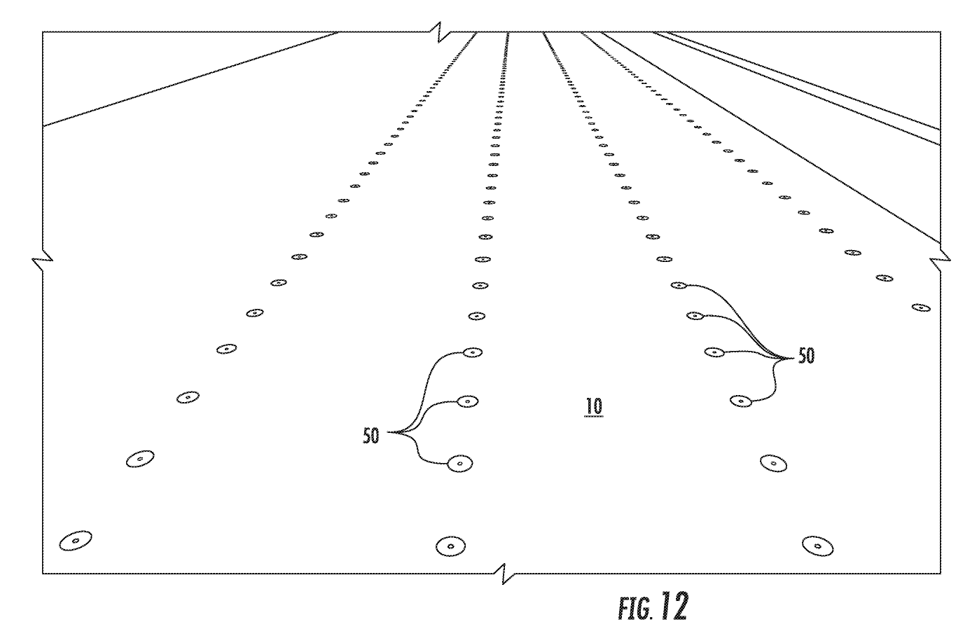

In some instances, it has been proposed to replace a sheet metal bracket or strap with a threaded fastener spanning the juncture of building substructures to establish the required continuous load path. For example, a long threaded fastener may be driven upward through the top plate of a wall and into a roof truss. The fastener engages both the wall and the truss to form a continuous load path between these building substructures. FIG. 10 illustrates an alternative installation tool 220 used to install long fasteners 222 to connect the top plate 224 of a wall to a roof truss 226. The illustrated fastener 222 establishes a connection between the wall and roof truss 226 as required by many construction codes and is intended to work in place of a hurricane tie bracket. Installation tool 220 can be provided with the same capability as installation tool 20 or bonding tool 120, as shown in FIG. 14. Installation tool 220 would report its position to the host computer 100 upon complete installation of each fastener 222. The installation tool 220 may be provided with a mechanical switch or sensor to detect a completed installation, or may be provided with a manually operated switch (not shown).

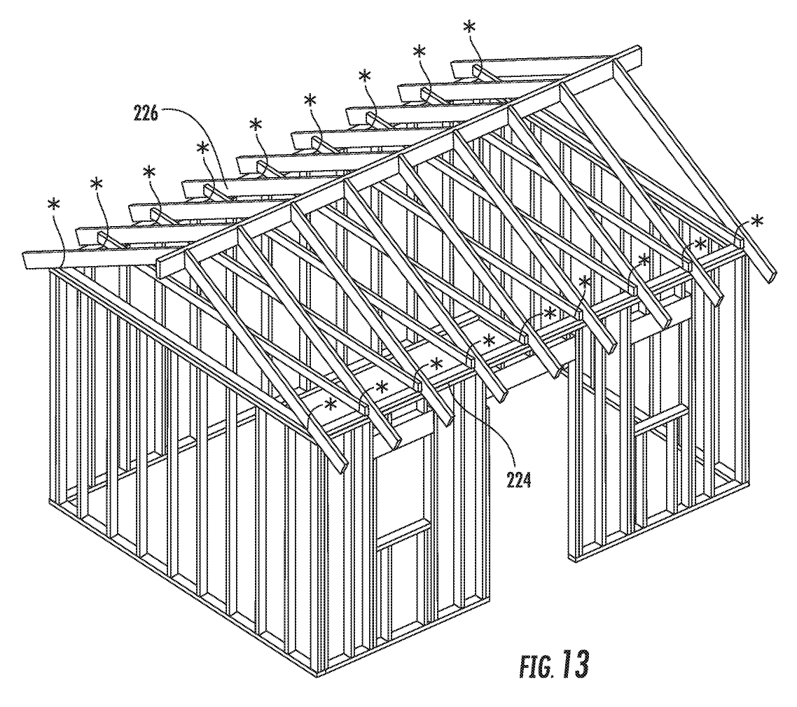

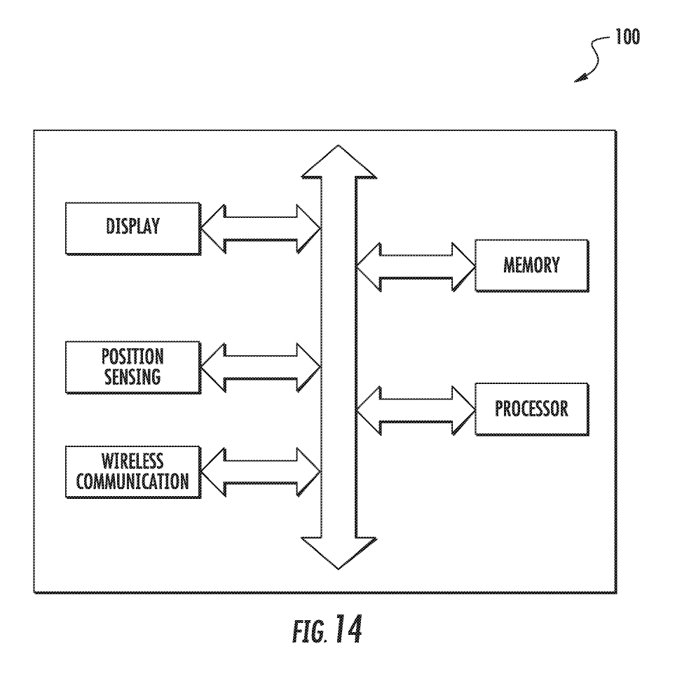

FIG. 13 is a three dimensional representation of a building structure that roughly corresponds to a virtual map that could be constructed by the host computer and associated software. The virtual map shows the building structural components and indicates with a star * each place where a fastener 222 is installed to connect the wall top plate 224 with a roof truss 226. Those involved with a construction project can use the virtual map to identify locations where additional fasteners 22 are needed to complete the code-required load path connections. The virtual map can be stored, updated, and used as an aid to building inspectors and those responsible for maintaining the structure. It will be understood that the virtual map can be updated to reflect changes in the structure, and to reflect various stages of construction.

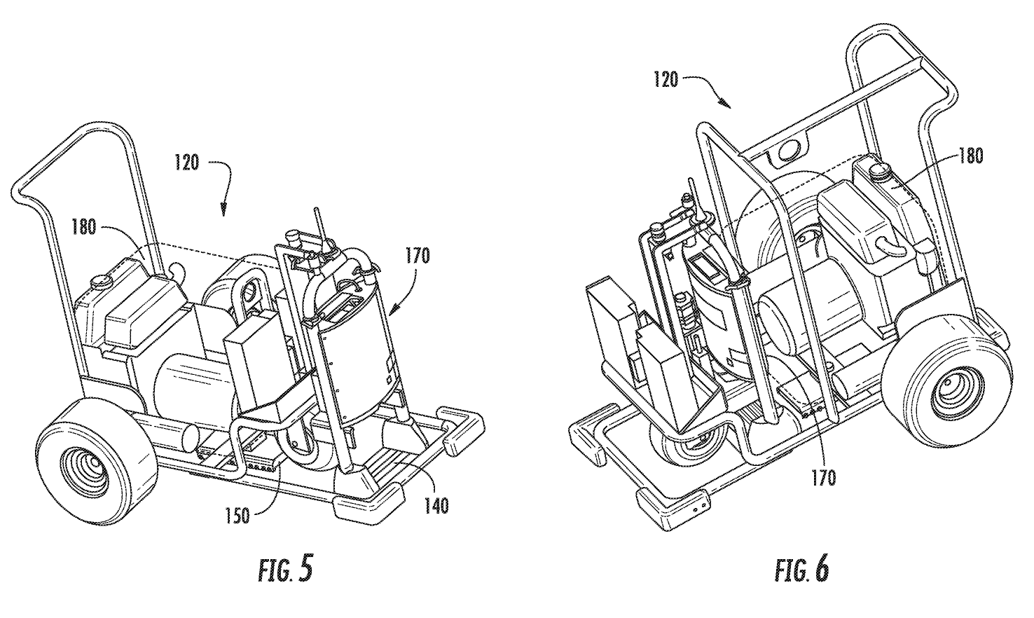

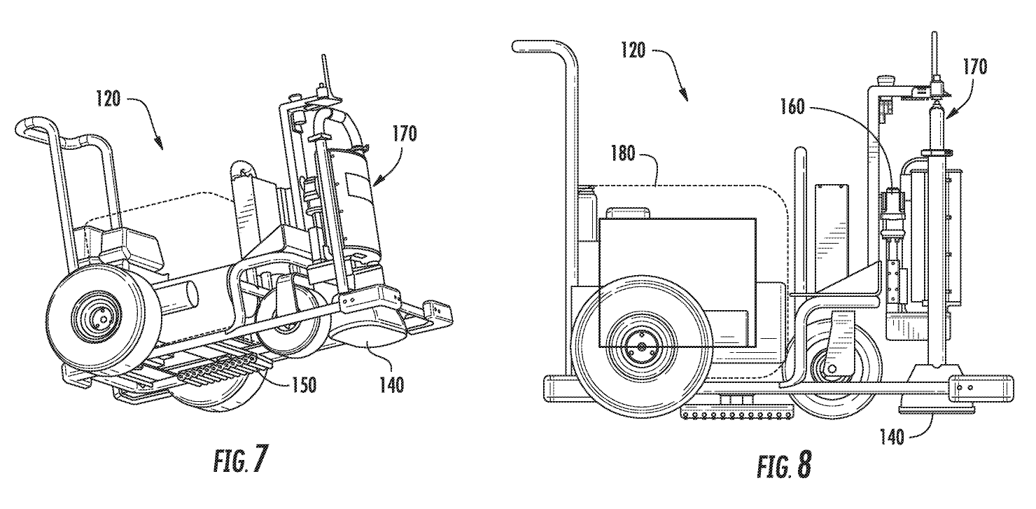

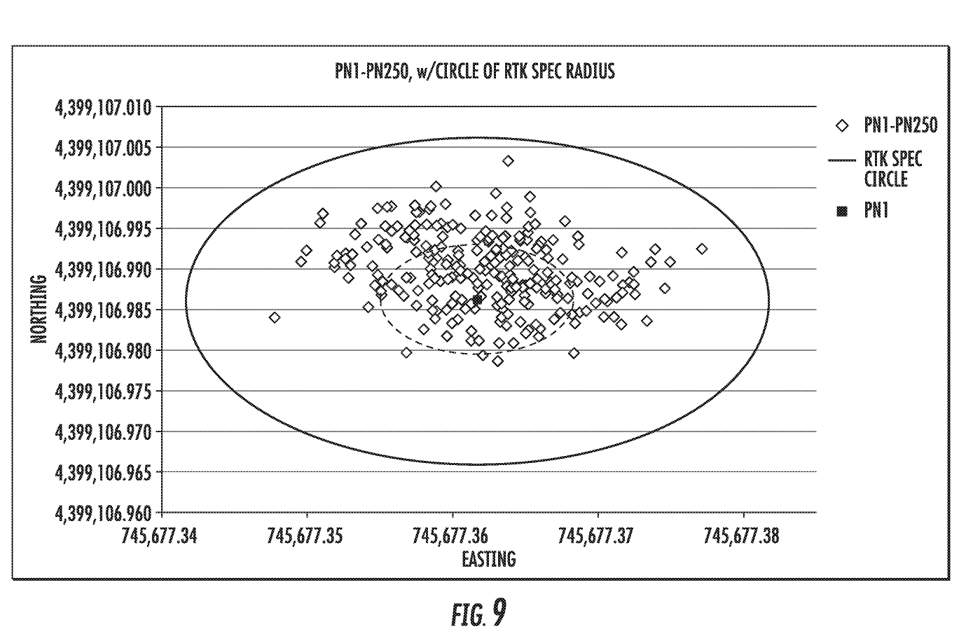

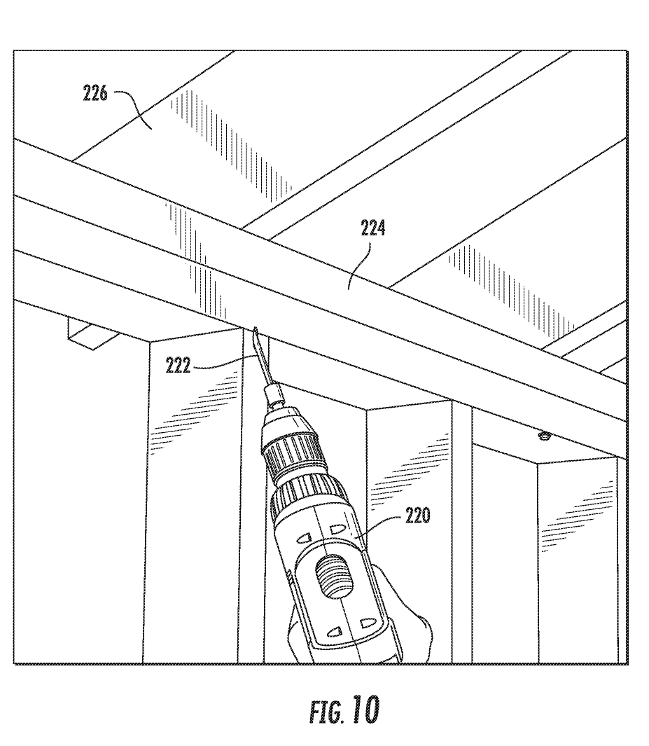

FIGS. 5-8 illustrate an automated bonding tool 120 that may be employed to inductively heat anchor plates 50. The automated bonding tool 120 includes the basic computer components illustrated in FIG. 14 and is equipped to wirelessly communicate with the other system units such as host computer 100 and fixed points 30. The automated bonding tool 120 includes position detection components 28 necessary to report the position of each completed bond with an anchor plate 50. The automated bonding tool 120 includes guidance and drive capability so the automated tool can be guided to a location on the roof by the host computer 100 or remotely controlled by an operator. The drive capability may include separate gear motors for each of the three wheels, so differential power applied to the gear motors permit guidance of the automated bonding tool across the flat roof 10. Alternative wheel and guidance arrangements will occur to those skilled in the art. The automated bonding tool 120 can then position an induction coil 140 over an anchor plate 50, lower the coil 140 onto the membrane and initiate an induction heating cycle to bond the membrane with the anchor plate 50. The disclosed automated bonding tool 120 includes rollers 150 arranged to compress and cool the membrane/plate bond to promote adhesion while the bonding tool is heating the next anchor plate 50 in the sequence. A linear actuator 160 is arranged to raise and lower the induction heating coil 140 for each induction heating cycle. The disclosed automated bonding tool 120 supports an induction heating tool 170 configured to be used as a separate, manually positioned device. An alternative automated bonding tool would include a non-removable, dedicated bonding coil and associated electronics.

The disclosed drive and guidance mechanisms for the automated bonding tool 120 provide “rough” guidance to position the tool 120 generally over the position of a bonding plate 50. However, it may be necessary to provide the tool 120 with “fine” position adjustment capability to place the induction coil 140 directly over the target induction plate 50. Such fine position capability can take the form of three axis control over the position of the induction coil 140 by including linear actuators arranged to move the induction heating tool 170, or coil 140 left and right as well as fore and aft relative to the tool 120. Such fine alignment may require means for detecting the exact position of a bonding plate 50 beneath a roofing membrane. Sensors to detect metal, magnetic sensors (the anchor plates are typically steel), ultrasonic, or other sensors may be arranged on the bottom of the tool 120 to provide location data to the tool 120 to permit correct alignment of the induction coil 140 with the induction plate 50. With the correct position over the plate 50, the linear actuator 160 is triggered to lower the induction coil 140 onto the membrane and initiate an induction heating cycle.

The disclosed automated bonding tool 120 includes an on-board generator 180 configured to generate power for the induction heating tool 170, and other bonding tool components, such as position detection 28, communications, guidance, drive and linear actuators 170. Alternatively, the automated bonding tool 120 could be powered using extension cords or the like.

The automated bonding tool 120 may report its position upon completion of a predetermined event, such as completion of a successful anchor plate/membrane bonding cycle. The virtual map can then be updated to show not only the location of each anchor plate 50, but also whether or not each adhesive plate 50 has been bonded to the membrane. Each anchor plate in the virtual map might have a first color before bonding and a second color after bonding. The disclosed system may employ the virtual map and status of each anchor plate 50 (not bonded/bonded) to guide the worker to anchor plates 50 in need of bonding. The disclosed system can confirm that all anchor plates in the virtual map are present and bonded to the membrane and provide a report to this effect.

Enhanced vision systems such as Google Glass may be used in combination with the proposed position reporting installation tools 20, 120, 220 and system to provide a record of installation of each building component, should that be necessary. For example, the construction worker could activate a recording function on the enhanced vision system to make a contemporaneous record of a component installation. It may only be necessary to record representative installations or those components that cannot be easily verified by inspectors. The proposed system could be configured to combine the building plans, virtual map of building components, and recordings of particular steps in the construction process into an electronic record for the project. Machine-aided tracking of large numbers of required steps is likely to reduce omissions and improve the overall quality of the project.

Different versions of a virtual map showing adhesive plates and their bonding status with the roof membrane can be used by construction personnel and inspectors to verify proper membrane installation, even though most of the roof components are obscured beneath the membrane. For example, the virtual map can be combined with the building plan to show each plate on the engineering drawing of the structure. Depictions of the virtual map may be provided to other interested parties such as membrane manufacturers for purposes of warranty coverage, or casualty insurers as verification that the roof system meets all relevant requirements.

The virtual map may also be employed to automate the process of bonding the roof membrane to the adhesive plates. The disclosed automated bonding tool 120 could be programmed to move along the roof to the location of each adhesive plate 50 and perform a bonding cycle at each plate. The automated bonding tool 120 may be semi-autonomous or robotic in nature. Once placed on the roof and provided with the necessary connections to electrical power and the disclosed system, the bonding tool 120 would move about the roof under guidance of the position detecting system and virtual map. The bonding tool 120 would report completion of each successful bonding cycle, permitting the system to update the virtual map to show each completed bond. An alternative embodiment of the proposed bonding tool 120 could be equipped with onboard power generation such as a generator 180, eliminating the need for a connection to facility power. Assuming it has sufficient fuel, such a self-powered, autonomous bonding tool 120 could remain on the roof making bonds for the duration of its fuel capacity. The bonding tool 120 could be equipped with blowers or brushes (not shown) to remove debris prior to commencement of each bonding cycle and components such as rollers 150 to cool the bonded plates under pressure to produce uniform, high strength bonds.

The disclosed tools, systems and methods are not dependent upon any particular GPS or location tracking technology. Any location/position tracking technology or GPS system having the required reliability and accuracy is compatible with the disclosed tools, systems and methods. Accuracy is an important aspect of the disclosed systems. Commercially available civilian GPS systems may lack the accuracy necessary to implement the disclosed tools, systems and methods. However, several known approaches can be used to provide accuracy of less than 1 cm, which is suitable for the disclosed systems.

The disclosed tools, systems, and methods have been discussed in the context of fastener delivery tools and membrane roof systems. However, the disclosed concepts encompass the marking and recording of component locations throughout a job site, including components or systems located below ground level throughout the building site. Buried structures include but are not limited to septic systems and septic tanks, water and sewer lines, gas lines, irrigation systems, and electrical service. A position detecting “marking tool” can be used to report the location of any building component or system for later reference. A resulting virtual map can be employed to find marked structures. Enhanced vision systems may also employ the virtual map to allow a user to “see” marked structures or components. Such assistance should remove most of the guesswork typically required to find buried structures such as septic tanks or sewer lines.

The virtual map may also be combined with photographs or engineering drawings to superimpose the location of the marked structures. Such a visual aid may assist with inspection and in finding buried or covered objects over the life of the project. One advantage of this approach is to show the actual installed position of marked components rather than their planned position. The virtual map can be combined with engineering plans for the structure to show the planned and actual position of marked components.

What is claimed:

1. A method for mapping components of a structure comprising:
a. establishing a position sensing system arranged to cover a job site, said position sensing system including a communication protocol;
b. providing components to be secured to the structure by an installation tool;
c. equipping the installation tool to communicate with said position sensing system and configuring said tool to report a position corresponding to an installed component upon completion of an installation event;
d. using the installation tool to secure one of said components to said structure resulting in an installed component, said installation tool reporting a position corresponding to the installed component to said position sensing system;
e. recording the position of said installed component; and
f. repeating steps d and e for each component to be installed.

2. The method of mapping components of a structure of claim 1, comprising:
producing a virtual map of the structure showing the position of said installed components.

3. The method of mapping components of a structure of claim 1, wherein said step of establishing includes providing a wireless communication protocol so that said system and said installation tools communicate wirelessly.

4. The method of mapping components of a structure of claim 1, wherein said step of establishing includes equipping said position sensing system to communicate with a global positioning system (GPS) satellite to determine the positions of said installed components.

5. The method of mapping components of a structure of claim 1, wherein said step of establishing includes using a global positioning system (GPS) device to establish the position of one or more fixed points proximate to said job site, said fixed points being in communication with said position sensing system; and
using said one or more fixed points to determine the installed positions of said installed components.

6. The method of mapping components of a structure of claim 1, comprising:
periodically calibrating said position sensing system with an alternative position sensing system to ensure accuracy.

7. The method of mapping components of a structure of claim 1, wherein said component is an anchor plate for a membrane roof and said installation event is the complete driving of a fastener to secure said anchor plate to an underlying roof structure.

8. The method of mapping components of a structure of claim 1, wherein said component is a roofing membrane and said installation event is the heating of an anchor plate secured to the roof structure to bond said roofing membrane to said roof structure.

9. The method of mapping components of a structure of claim 1, wherein said component is an axially extended fastener installed to connect the top plate of a wall to a roof truss and said installation event is the completed driving of said extended fastener.

10. The method of mapping components of a structure of claim 2, wherein said installation tool is a self-propelled tool configured to autonomously execute an installation event, said method comprising:
using said virtual map to direct the self-propelled tool to the position of an installed component;
initiating a second installation event by said self-propelled tool, by means of said communications protocol;
said self-propelled tool reporting a second position corresponding to the second installation event; and
updating, by said host computer, said virtual map to show occurrence of said second installation event.

11. A construction system comprising:
a position sensing network covering a job site;
a host computer in communication with said position sensing network and including at least one communication protocol;
an installation tool in communication with said host computer and configured to report an installed position corresponding to an installed building component upon occurrence of a completed installation event; and
a plurality of building components to be secured to a structure by said installation tool,
wherein said installation tool reports the location of each said building component upon occurrence of the completed installation event and said host computer records each said installed position.

12. The construction system of claim 11, wherein said host computer uses said installed positions to produce a virtual map of said structure showing said installed positions.

13. The construction system of claim 11, comprising a fixed point, the position of which is determined by global positioning system (GPS) satellite, and said fixed point is in communication with said position sensing system, which employs position signals from said fixed point and said installation tool to calculate said installed positions.

14. The construction system of claim 11, wherein said installation tool is a self-propelled tool configured to autonomously execute an installation event, said host computer programmed with a virtual map of the structure and guides said self-propelled tool to a pre-determined location using said virtual map and said communications protocol, said host computer initiating an installation event by said self-propelled tool, by means of said communications protocol, said self-propelled tool reporting an event position corresponding to the second installation event, and said host computer updates said virtual map to show occurrence of said installation event.

15. The construction system of claim 11, comprising a supplementary position sensing system used to calibrate said position sensing network.

16. The construction system of claim 11, wherein said building components are anchor plates secured to a roof structure, said installation tool is an induction heating tool and said installation event is an induction heating cycle where said induction heating tool is placed on top of a roofing membrane at the location of a bonding plate, said bonding plate is inductively heated by said induction heating tool to bond said membrane to said anchor plate, the position of each completed induction heating cycle recorded by said construction system, and a virtual map of said structure and said installed components generated by said host computer.

17. The building construction system of claim 14, wherein said self-propelled tool is equipped to locate a target anchor plate beneath a roofing membrane at a position corresponding to said pre-determined location, said self-propelled tool includes an induction coil for heating said anchor plate to bond said membrane to said anchor plate, completion of said bonding being said second installation event.

18. The building construction system of claim 17, wherein said self-propelled tool is equipped to apply pressure to the location corresponding to a completed bond between membrane and anchor plate.

19. The building construction system of claim 17, wherein said self-propelled tool is equipped to apply pressure to the location corresponding to a completed bond and cool said location.

20. The building construction system of claim 17, wherein said induction coil may be used independently of said self-propelled tool.
